(19) United States
(12) Patent Application Publication
(10) Pub. No.: US 2023/0259332 A1
(43) Pub. Date: Aug. 17, 2023

(54) PROCESSING UNIT FOR PERFORMING MULTIPLY-ACCUMULATE OPERATIONS

(71) Applicant: Arm Limited, Cambridge (GB)

(72) Inventor: Fredrik Peter STOLT, Cambridge (GB)

(21) Appl. No.: 18/167,196

(22) Filed: Feb. 10, 2023

(30) Foreign Application Priority Data
Feb. 17, 2022 (GB) 2202137.2

(51) Int. Cl. G06F 7/544; G06F 7/57

(52) U.S. Cl. CPC G06F 7/5443; G06F 7/57

(57) ABSTRACT

A processing unit comprises a multiply-accumulate engine and a control unit. The engine comprises a plurality of dot product units, switching circuitry, a plurality of adders, and a plurality of accumulators. The switching circuitry, coupled between the dot product units and the adders, is configurable to selectively couple each of the adders to one of the plurality of dot product units. The adders are each associated with a respective accumulator of the plurality of accumulators. In a processing cycle, each of the dot product units is configured to output a product value, the control unit is operable to configure the switching circuitry such that each of the adders is coupled to a selected dot product unit of the plurality of dot product units, and each of the adders is configured to add the product value of the selected dot product unit to an accumulated value stored by the respective accumulator.

### CROSS-REFERENCE TO RELATED APPLICATION

The present application claims priority pursuant to 35 U.S.C. 119(a) to United Kingdom Patent Application No. 2202137.2, filed on Feb. 17, 2021, which application is incorporated herein by reference in its entirety.

### BACKGROUND OF THE INVENTION

### Field of the Invention

The present invention relates to a processing unit for performing multiply-accumulate operations.

### Description of the Related Technology

A processing unit may comprise a multiply-accumulate (MAC) engine for performing MAC operations. In some applications, processing units may be required to perform a large number of MAC operations per second. However, the power consumption associated with such rates may limit their use in devices having a low power budget.

### SUMMARY

In a first embodiment, there is provided a processing unit comprising a multiply-accumulate (MAC) engine and a control unit, wherein: the MAC engine comprises a plurality of dot product units, switching circuitry, a plurality of adders, and a plurality of accumulators; the switching circuitry is coupled between the dot product units and the adders and is configurable to selectively couple each of the adders to one of the plurality of dot product units; each of the adders is associated with a respective accumulator of the plurality of accumulators; and in a processing cycle, each of the dot product units is configured to output a product value, the control unit is operable to configure the switching circuitry such that each of the adders is coupled to a selected dot product unit of the plurality of dot product units, and each of the adders is configured to add the product value of the selected dot product unit to an accumulated value stored by the respective accumulator.

In a second embodiment, there is provided a multiply-accumulate engine comprising a plurality of dot product units, switching circuitry, a plurality of adders, and a plurality of accumulators, wherein: the switching circuitry is coupled between the dot product units and the adders and is configurable to selectively couple each of the adders to one of the plurality of dot product units; and each of the adders is associated with a respective accumulator of the plurality of accumulators.

In a third embodiment, there is provided a method of performing multiply-accumulate operations comprising: in a first processing cycle, using a dot product unit to output a first product value, and adding the first product value to a first accumulated value of a first accumulator; and in a second processing cycle, using the dot product unit to output a second product value, and adding the second product value to a second accumulated value of a second accumulator.

Further features will become apparent from the following description, given by way of example only, which is made with reference to the accompanying drawings.

### BRIEF DESCRIPTION OF THE DRAWINGS

FIG. 1 is a block diagram of an example system;

FIG. 2 is an example of a convolution operation;

FIG. 3 is an example of a multiply-accumulate engine;

FIG. 4 details the weights and input values of the engine of FIG. 3 over different processing cycles when performing the convolution operation of FIG. 2;

FIG. 5 is an additional example of a multiply-accumulate engine;

FIG. 6 details the weights and input values of the engine of FIG. 5 over different processing cycles when performing the convolution operation of FIG. 2;

FIG. 7 illustrates (a) the sequence of the weights employed in the processing cycles of FIG. 6, as well as (b) a first alternative sequence of weights, and (c) a second alternative sequence of weights;

FIG. 8 is a further example of a convolution operation;

FIG. 9 is a further example of a multiply-accumulate engine;

FIG. 10 details the weights and input values of the engine of FIG. 9 over different processing cycles when performing the convolution operation of FIG. 8; and

FIG. 11 is an example of a method for performing multiply-accumulate operations.

### DETAILED DESCRIPTION OF CERTAIN INVENTIVE EMBODIMENTS

Details of systems and methods according to examples will become apparent from the following description, with reference to the Figures. In this description, for the purpose of explanation, numerous specific details of certain examples are set forth. Reference in the specification to “an example” or similar language means that a particular feature, structure, or characteristic described in connection with the example is included in at least that one example, but not necessarily in other examples. It should further be noted that certain examples are described schematically with certain features omitted and/or necessarily simplified for ease of explanation and understanding of the concepts underlying the examples.

In examples described herein, there is provided a multiply-accumulate (MAC) engine, and a processing unit comprising the MAC engine. The MAC engine comprises a plurality of dot product units, switching circuitry, a plurality of adders, and a plurality of accumulators. The switching circuitry is coupled between the dot product units and the adders and is configurable to selectively couple each of the adders to one of the plurality of dot product units. Each of the adders is associated with a respective accumulator of the plurality of accumulators. In a processing cycle, each of the dot product units outputs a product value, and the switching circuitry is configured such that each of the adders is coupled to a selected dot product unit of the plurality of dot product units. Each of the adders then adds the product value of the selected dot product unit to an accumulated value stored by the respective accumulator. By employing switching circuitry between the dot product units and the adders, MAC operations may be performed at reduced power consumption. For example, when performing a sequence of MAC operations, input values used in the MAC operations of one processing cycle may also be used in the MAC operations of a subsequent processing cycle. The inputs to at least some of the dot product units may therefore be left unchanged between processing cycles, thereby conserving power, and the switching circuitry may be configured such that the product values of the dot product units are nevertheless output to the appropriate accumulators.

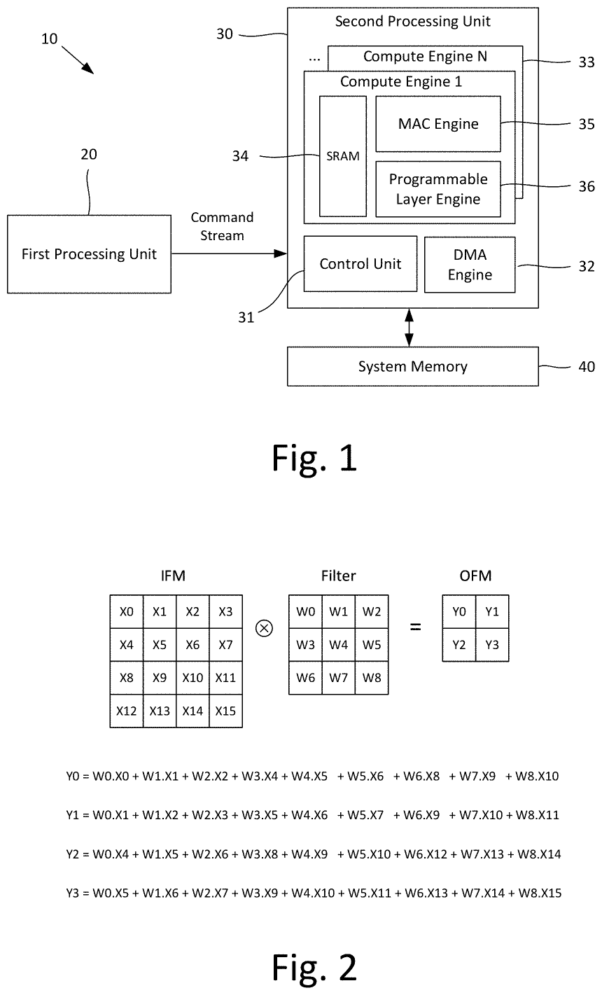

FIG. 1 shows an example of a system 10, which may be used to implement, in whole or in part, a neural network. The system 10 comprises a first processing unit 20, a second processing unit 30, and a system memory 40. In order to simplify the following description, as well as to better distinguish the two processing units, the first processing unit 20 will hereafter be referred to as the CPU and the second processing unit 30 will be referred to as the NPU. The choice of label for each processing unit should not, however, be interpreted as implying a particular architecture or functionality beyond that described below.

The NPU 30 comprises a control unit 31, a direct memory access (DMA) engine 32, and a plurality of compute engines 33. The control unit 31 manages the overall operation of the NPU 30. The DMA engine 32, in response to instructions from the control unit 31, moves data between the system memory and the local memory of the compute engines 33, as well as between the local memory of different compute engines 33.

Each of the compute engines 33 comprises local memory 34, a multiply-accumulate (MAC) engine 35, and a programmable layer engine 36. The compute engines 33, again under instruction from the control unit 31, perform operations on data stored in the local memory 34.

In this example, the local memory 34 comprises static random access memory (SRAM). The local memory 34 stores input data to be processed by the compute engine 33, as well as output data processed by the compute engine 33. For example, when performing operations of a convolutional neural network, the local memory 34 may store a portion of the input feature map (IFM), the weights of the filter, and a portion of the output feature map (OFM). In some examples, the weights of the filter stored in the local memory 34 may be compressed and the compute engine 33 may comprise a weight decoder to decompress the weights for use by the MAC engine 35.

The MAC engine 35 performs MAC operations on the input data. The MAC engine 35 comprises a plurality of dot product units (DPUs), adders and accumulators. As a result, the MAC engine 35 is capable of performing a plurality of MAC operations per processing cycle. In a conventional MAC engine, each DPU is typically coupled to a respective adder and accumulator to define a discrete MAC unit. As a result, the output of each DPU is always added to the same accumulator. However, as explained below in more detail, the MAC engine 35 of the present example comprises switching circuitry coupled between the DPUs and the adders. The switching circuitry is configurable such that each of the adders may be coupled to any one of the DPUs. As a result, the output of each DPU may be added to any one of the accumulators. This then has potential benefits for power consumption, as detailed below.

The programmable layer engine 36 may perform additional operations on the data output by the MAC engine 35, such as pooling operations and/or activation functions.

In use, the CPU 20 outputs a command stream to the NPU 30. The command stream comprises a set of instructions for performing, all or part, of the operations that define the neural network. In the present example, the command stream comprises instructions for implementing operations of a convolutional neural network. In other examples, the command stream may comprise instructions for implementing other types of neural network, such as recurrent neural networks.

In response to instructions within the command stream, the NPU 30 operates on an input feature map (IFM) and generates in response an output feature map (OFM). The IFM may be any data structure that serves as an input of an operation of the neural network. Similarly, the OFM may be any data structure that is output by the operation of the neural network. Accordingly, the IFM and the OFM may be a tensor of any rank.

An instruction within the command stream may comprise the type of operation to be performed, the locations in the system memory 40 of the IFM, the OFM and, where applicable, the weights, along with other parameters relating to the operation, such as the number of kernels, kernel size, stride, padding and/or activation function.

The size of the IFM may exceed that capable of being processed by the NPU 30. An instruction may therefore additionally include a block size to be used by the NPU 30 when performing the operation. In response, the NPU 30 divides the IFM into a plurality of IFM blocks defined by the block size, and operates on each IFM block to generate an OFM block.

Each of the plurality of compute engines 33 may operate on a microblock of the IFM. For example, the DMA engine 32, under instruction from the control unit 31, may load a microblock of the IFM together with the relevant weights of the filter into the local memory 34. The MAC engine 35 then performs a convolution operation on the data stored in the local memory 34 through a sequence of MAC operations. A more detailed description of the MAC engine 35 and its operation is provided below with reference to FIGS. 2 to 10. The programmable layer engine 36 may then operate on the microblock of the OFM output by the MAC engine 35. For example, the programmable layer engine 36 may perform an activation function and/or a pooling operation on the microblock of the OFM. The OFM microblocks generated by the compute engines 33 may then be appended to create an OFM block.

FIG. 2 illustrates an example of a convolution operation. In this example, the IFM is a 4×4 matrix, the filter comprises a single kernel that is a 3×3 matrix, and the stride is 1. Consequently, the OFM is a 2×2 matrix. FIG. 2 also details the equations that define the elements Y0-Y3 of the OFM.

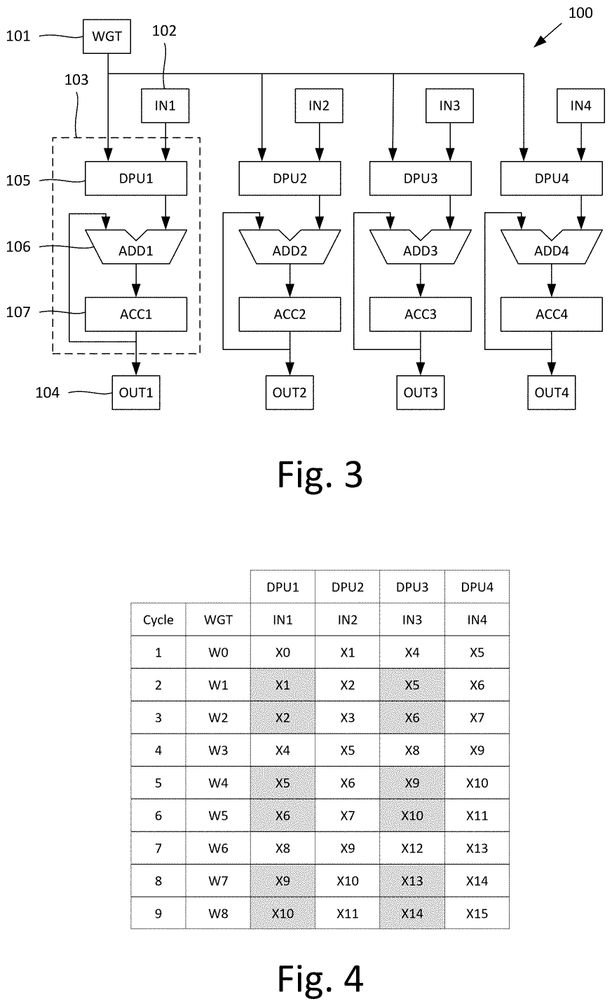

FIG. 3 illustrates an example of a MAC engine 100 that may be used to perform the convolution operation illustrated in FIG. 2. The MAC engine 100 comprises a weight register 101, a plurality of input registers 102, a plurality of MAC units 103, and a plurality of output registers 104. Each MAC unit 103 comprises a DPU 105, an adder 106 and an accumulator 107. The DPU 105 has a first input coupled to the weight register 101, a second input coupled to a respective input register 102, and an output coupled to an input of the adder 106. The adder 106 has a first input coupled to the output of the DPU 105, a second input coupled to the output of the accumulator 107, and an output coupled to the input of the accumulator 107. The accumulator 107 comprises an input coupled to the output of the adder 106, and an output coupled to both the second input of the adder 106 and to a respective output register 104.

With each processing cycle, the DPU 105 of each MAC unit 103 outputs a product value corresponding to the product of the values stored in the weight register 101 and the respective input register 102. The adder 106 then adds the product value to an accumulated value stored in the accumulator 107.

The MAC engine 100 comprises a MAC unit 103 for each element of the OFM. Accordingly, in performing the convolution operation of FIG. 2, the MAC engine 100 comprises four MAC units 103.

Each MAC unit 103 performs one or more MAC operations per processing cycle according to the depth of the DPU 105. For a DPU 105 of depth N, each MAC unit 103 performs N MAC operations per processing cycle, and the values stored in the weight and input registers 101,102 are vectors of depth N. In order to simplify the following discussion, the DPUs 105 of this particular example have a depth of one. Each DPU 105 therefore operates as, and indeed may take the form of, a multiplier. The values stored by the weight and input registers 101,102 are therefore scalar, and each MAC unit 103 performs one MAC operation per processing cycle.

In the first processing cycle, the weight register WGT is loaded with weight W0 of the filter. The first input register IN1 is then loaded with value X0 of the IFM, the second input register IN2 is loaded with value X1, the third input register IN3 is loaded with value X4, and the fourth input register IN4 is loaded with value X5. Consequently, at the end of the first processing cycle, the first accumulator ACC1 stores the value W0·X0, the second accumulator ACC2 stores the value W0·X1, the third accumulator ACC3 stores the value W0·X4, and the fourth accumulator ACC4 stores the value W0·X5. In the second processing cycle, the weight register WGT is loaded with weight W1 of the filter. The first input register IN1 is then loaded with value X1 of the IFM, the second input register IN2 is loaded with value X2, the third input register IN3 is loaded with value X5, and the fourth input register IN4 is loaded with value X6. Consequently, at the end of the second processing cycle, the first accumulator ACC1 stores the accumulated value W0·X0+W1·X1, the second accumulator ACC2 stores the accumulated value W0·X1+W1·X2, the third accumulator ACC3 stores the accumulated value W0·X4+W1·X5, and the fourth accumulator ACC4 stores the accumulated value W0·X5+W1·X6. This process then continues for nine processing cycles in total.

FIG. 4 details the weights and the IFM values for each of the DPUs of the MAC engine over the nine processing cycles. At the end of the ninth cycle, the first accumulator ACC1 stores the accumulated value Y0 defined in FIG. 2, the second accumulator ACC2 stores the accumulated value Y1, the third accumulator ACC3 stores the accumulated value Y2, and the fourth accumulator ACC4 stores the accumulated value Y3. The accumulated value stored by each of the accumulators is then output to the respective output register.

It can be seen in FIG. 4 that, for each processing cycle, each of the input registers is loaded with a new value. In particular, each of the input registers is loaded with a different value of the IFM. Loading an input register with a new value naturally consumes electrical power. In addition to this, the inputs to each of the DPUs (i.e., the weight and the value of the IFM) change with each processing cycle. Changing the inputs to a DPU requires the switching of internal bits or states within the DPU, which again consumes electrical power.

Although each of the input registers is loaded with a new value in each processing cycle, some of the values of the IFM that are used in one processing cycle are also used in the subsequent processing cycle. For example, values X1 and X5 of the IFM are used by DPU2 and DPU4 in the first processing cycle, and by DPU1 and DPU3 in the second processing cycle. A reduction in power consumption may therefore be achieved by reusing values between consecutive processing cycles.

In one example, the MAC engine of FIG. 3 may be adapted to comprise multiplexers coupled between the input registers and the DPUs. Each multiplexer comprises a plurality of inputs and a single output. Each of the inputs is coupled to one of the input registers, and the output is coupled to an input of a respective DPU. The input of the multiplexer can then be selected such that the DPU is coupled to a different input register in different processing cycles. The inputs of the multiplexers may then be selected in such a way as to reduce the number of changes made to the input registers, thereby reducing power consumption. For example, in a first processing cycle, the input registers IN1 to IN4 may be loaded with values X0, X1, X4 and X5 of the IFM. The inputs of the multiplexers may then be selected such that DPU1 is coupled to the first input register IN1 storing X0, DPU2 is coupled to the second input register IN2 storing X1, DPU3 is coupled to the third input register IN3 storing X4, and DPU4 is coupled to the fourth input register IN4 storing X5. In the second processing cycle, the first and third input registers IN1, IN3 are loaded with values X2 and X6 respectively. The second and fourth input registers IN2, IN4 are left unchanged and therefore continue to store values X1 and X5. The inputs of the multiplexers are then selected such that DPU1 is coupled to the second input register IN2 storing X1, DPU2 is coupled to the first input register IN1 storing X2, DPU3 is coupled to the fourth input register IN4 storing X5, and DPU4 is coupled to the third input register IN3 storing X6. In this way, the number of changes to the input registers is reduced and therefore a reduction in power consumption may be achieved. However, although the number of changes to the input registers is reduced, the inputs to each of the DPUs nevertheless continue to change with each and every processing cycle.

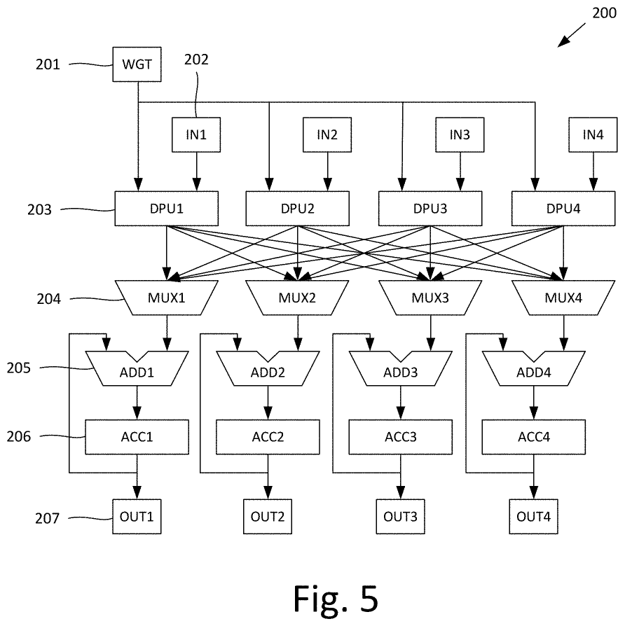

FIG. 5 illustrates an additional example of a MAC engine 200. The MAC engine 200 may be employed in each of the compute engines 33 of the NPU 30 of FIG. 1. The MAC engine 200 comprises a weight register 201, a plurality of input registers 202, a plurality of DPUs 203, a plurality of multiplexers 204, a plurality of adders 205, a plurality of accumulators 206, and a plurality of output registers 207.

Each of the DPUs 203 comprises a first input coupled to the weight register 201, a second input coupled to a respective input register, and an output coupled to an input of each of the multiplexers 204. Each of the multiplexers 204 comprises a plurality of inputs and a single output. Each of the inputs is coupled to the output of one of the DPUs 203, and the output is coupled to an input of a respective adder 205. Each of the adders 205 comprises a first input coupled to the output of the respective multiplexer 204, a second input coupled to the output of a respective accumulator 206, and an output coupled to the input of the respective accumulator 206. Each of the adders 205 is therefore associated with a respective accumulator 205, which is to say that each of the adders 205 adds a value received at its first input to a respective accumulator. Each of the accumulators 206 comprises an input coupled to the output of the respective adder 205, and an output coupled to both the second input of the respective adder 205 and to a respective output register 207.

With each processing cycle, each of the DPUs 203 outputs a product value corresponding to the product of the values stored in the weight register 201 and its respective input register 202. The product value is then output to each of the multiplexers 204. For each multiplexer 204, an input of the multiplexer is selected such that its respective adder 205 is coupled to one of the DPUs 203. Each of the adders 205 then adds the product value of the selected DPU 203 to the accumulated value stored in its respective accumulator 206.

Again, in order to simplify the following discussion, each of the DPUs 203 of the present example has a depth of one and therefore operates as, and indeed may take the form of, a multiplier. The values stored by the weight and input registers 201,202 are therefore scalar. In other examples, each of the DPUs 203 may have a depth greater than one, and the values stored in the weight and input registers 201,202 may be vectors of corresponding depth. Each DPU 203 then outputs a scalar product of the two vectors stored in the weight register 201 and the respective input register 202. Accordingly, where reference is made to a value of the IFM or a weight of the filter, it should be understood that these values may be scalars or vectors.

The MAC engine 200 again comprises an accumulator 206 for each element of the OFM. Accordingly, in performing the convolution operation of FIG. 2, the MAC engine 200 comprises four accumulators 206, and therefore four DPUs 203, four multiplexers 204 and four adders 205.

The MAC engine 200 performs a plurality of MAC operations per processing cycle. In the first processing cycle, the weight register WGT is loaded with weight W0 of the filter. The first input register IN1 is then loaded with value X0 of the IFM, the second input register IN2 is loaded with value X1, the third input register IN3 is loaded with value X4, and the fourth input register IN4 is loaded with value X5. The inputs of the multiplexers are then selected such that the product value of DPU1 is output to the adder of the first accumulator ACC1, the product value of DPU2 is output to the adder of the second accumulator ACC2, the product value of DPU3 is output to the adder of the third accumulator ACC3, and the product value of DPU4 is output to the adder of the fourth accumulator ACC4. Consequently, at the end of the first processing cycle, the first accumulator MUL1 stores the value W0·X0, the second accumulator MUL2 stores the value W0·X1, the third accumulator MUL3 stores the value W0·X4, and the fourth accumulator MUL4 stores the value W0·X5.

In the second processing cycle, the weight register WGT is loaded with weight W1 of the filter. The first and third input registers IN1, IN3 are loaded with values X2 and X6 respectively. The second and fourth input registers IN2, IN4 are left unchanged and therefore continue to store values X1 and X5. The inputs of the multiplexers are then selected such that product value W1·X2 of DPU1 is output to the adder of the second accumulator ACC2, the product value W1·X1 of DPU2 is output to the adder of the first accumulator ACC1, the product value W1·X6 of DPU3 is output to the adder of the fourth accumulator ACC4, and the product value W1·X5 of DPU4 is output to the adder of the third accumulator ACC3. Consequently, at the end of the second processing cycle, the first accumulator ACC1 stores the accumulated value W0·X0+W1·X1, the second accumulator ACC2 stores the accumulated value W0·X1+W1·X2, the third accumulator ACC3 stores the accumulated value W0·X4+W1·X5, and the fourth accumulator ACC4 stores the accumulated value W0·X5+W1·X6. This process is then repeated for nine processing cycles in total.

FIG. 6 details the weights and the IFM values for each of the DPUs of the MAC engine over the nine processing cycles. FIG. 6 also details the particular accumulator to which the product value of each of the DPUs is added. Where a value of the IFM is used in consecutive processing cycles, the input register storing that value is unchanged. The inputs of the multiplexers are then selected such that the product values output by the DPUs are directed to the appropriate accumulators. Those input registers having values that are unchanged from the previous processing cycle are shaded in FIG. 6.

At the end of the ninth processing cycle, the first accumulator ACC1 stores the accumulated value Y0 defined in FIG. 2, the second accumulator ACC2 stores the accumulated value Y1, the third accumulator ACC3 stores the accumulated value Y2, and the fourth accumulator ACC4 stores the accumulated value Y3. The accumulated value stored by each of the accumulators is then output to the respective output register.

With the example MAC engine illustrated in FIG. 3, each of the input registers changes with each processing cycle; that is to say that each input register is loaded with a new value for each processing cycle. Accordingly, when used to perform the convolution operation of FIG. 2, there are a total of 36 input register changes. By contrast, with the MAC engine illustrated in FIG. 5, the same convolution operation may be performed with just 20 input register changes. As a result, the convolution operation may be performed at a lower power cost.

In addition to fewer changes to the input registers, there are fewer changes to the inputs of the DPUs. With the example MAC engine illustrated in FIG. 3, the inputs to each DPU (i.e., the weight and the IFM value) change with each processing cycle. By contrast, with the MAC engine illustrated in FIG. 5, there are processing cycles for which one of the inputs to some of the DPUs is unchanged. For example, in the second processing cycle, one of the inputs (value X1) to DPU2 is unchanged. Similarly, one of the inputs (value X5) to DPU4 is unchanged. In the example illustrated in FIG. 6, there are 16 instances (shaded cells) for which an input to a DPU is unchanged. Where an input to a DPU is unchanged, there is no requirement to switch the internal bits or states within the DPU that represent that input value. As a result, further power savings may be made.

The MAC engine of FIG. 5 is therefore capable of performing convolution operations, and more generally MAC operations, at a lower power consumption. The MAC engines of the NPU may be required to perform a large number of MAC operations per second. Accordingly, significant power and energy savings may be achieved, which may be of particular benefit for devices having a low power and/or energy budget, such as mobile devices or internet-of-things devices.

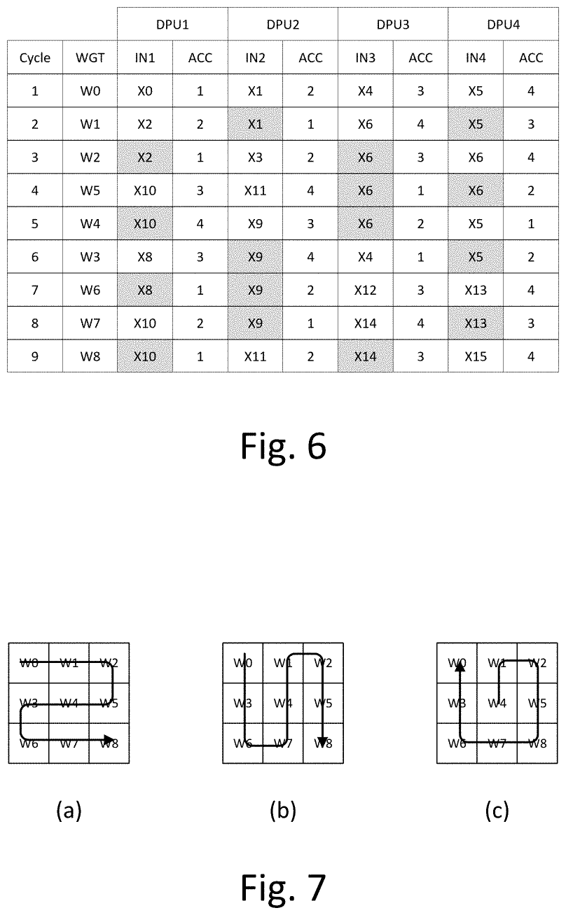

In the example shown in FIG. 6, the change in the weight with each processing cycle does not follow an incremental sequence. Instead, the change in the weight follows a serpentine pattern through the filter, as shown in FIG. 7(a). This is done in order to maximize the number of times that values of the IFM can be reused. In particular, by employing a sequence in which movement through the filter is from one weight to a contiguous weight (in the x, y or z direction of the filter), the number of reuses may be increased. In the example of FIG. 7(a), the sequence of weights follows a horizontal serpentine pattern through the filter. However, other sequences are possible that would result in the same number reuses of IFM values. By way of example, the sequence of weights may follow a vertical serpentine pattern through the filter, as shown in FIG. 7(b), or a spiral pattern, as shown in FIG. 7(c). Other sequences that do not move through the filter from one weight to a contiguous weight are nevertheless possible, and reuse of IFM values (albeit potentially fewer reuses) may still be achieved. For example, if the weights were to follow the incremental sequence detailed in FIG. 4, there would nevertheless be 12 instances for which values of the IFM may be reused.

The convolution operation illustrated in FIG. 2 is relatively simple and was chosen so as to simplify the above discussion. However, the MAC engine and the principles described above may be used to perform alternative convolution operations, including 3D convolutions, and power savings may be achieved whenever values of the IFM are used more than once. This situation seems likely to arise whenever the size of the filter is greater than the stride.

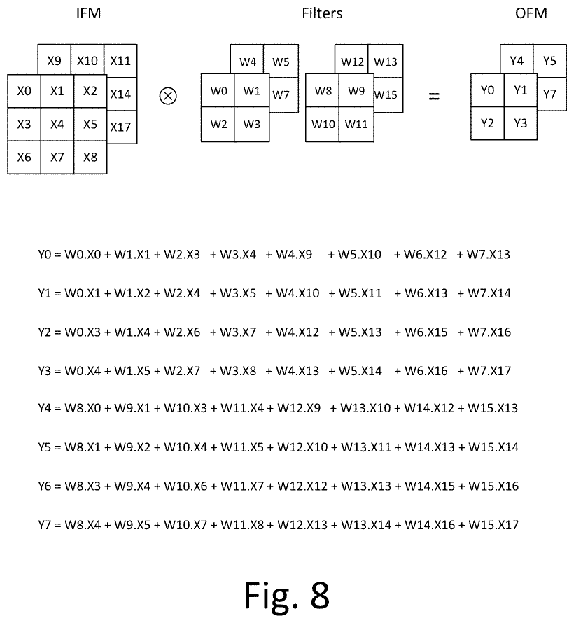

FIG. 8 illustrates a further example of a convolution operation. In this further example, the IFM is a 3×3×2 matrix, the filter comprises four kernels, each of which is a 2×2 matrix, and the stride is 1. Consequently, the OFM is a 2×2×2 matrix. FIG. 8 also details the equations that define the elements Y0-Y7 of the OFM.

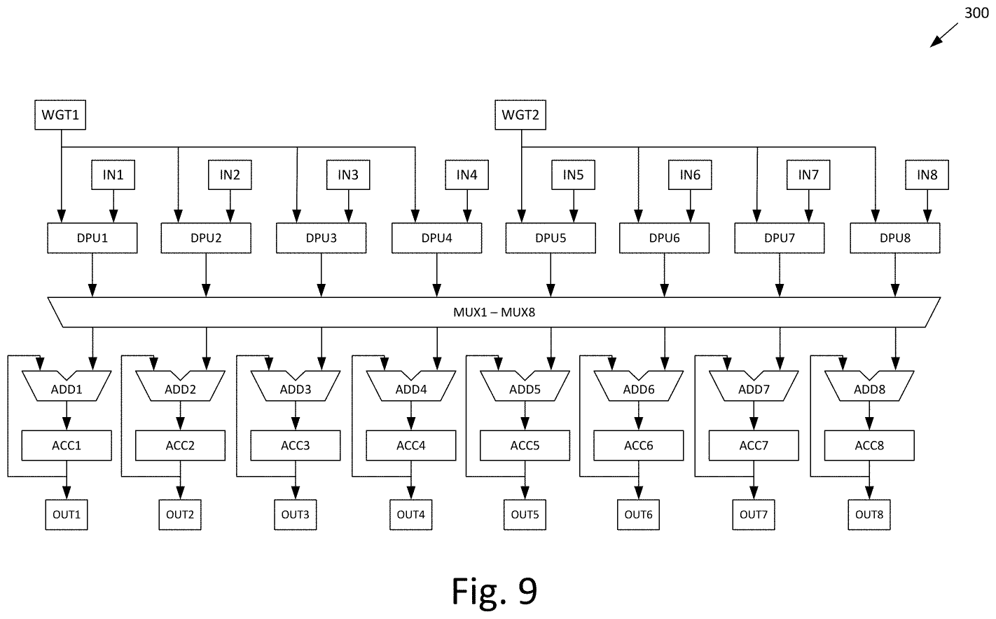

FIG. 9 illustrates a MAC engine 300 for performing the convolution operation of FIG. 8. Again, the MAC engine 300 comprises an accumulator for each element of the OFM. Accordingly, in this example, the MAC engine 300 comprises eight accumulators, and therefore eight dot product units, eight multiplexers and eight adders. In the example of FIG. 9, the eight multiplexers are represented as a single unit in order to simplify the connections between the dot product units and the multiplexers.

In contrast to the example of FIG. 5, the MAC engine 300 comprises two weight registers WGT1 and WGT2. Four of the DPUs (DPU1-DPU4) are then coupled to a first of the weight registers WGT1, and four of the DPUs (DPU5-DPU8) are coupled to a second of the weight registers WGT2.

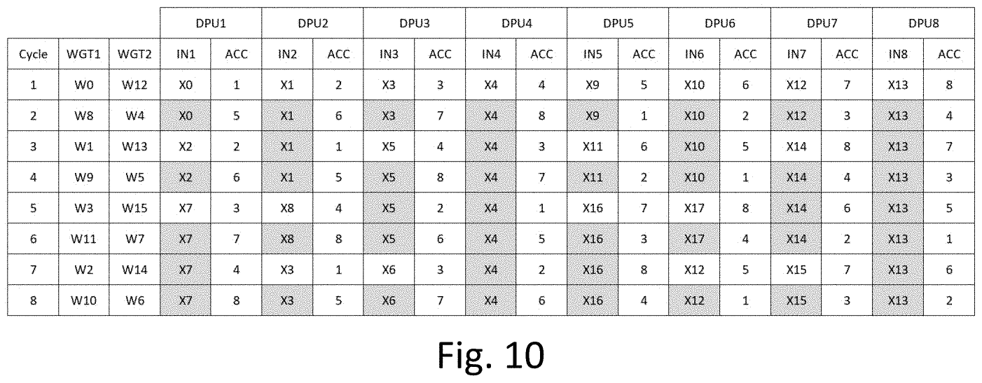

In performing the convolution operation of FIG. 8, the MAC engine performs the MAC operations detailed in FIG. 10. At the end of the eighth processing cycle, each of the accumulators stores an accumulated value that corresponds to a respective value of OFM. More particularly, the first accumulator ACC1 stores the accumulated value Y0 defined in FIG. 8, the second accumulator ACC2 stores the accumulated value Y1, the third accumulator ACC3 stores the accumulated value Y2, and so on. The accumulated value stored by each of the accumulators is then output to the respective output register.

Again in this example, the changes in the weights with each processing cycle do not follow an incremental sequence. Instead, the changes follow a sequence that maximizes the number of times that values of the IFM may be reused. In this particular example, there are 44 instances (shaded cells) for which values of the IFM are reused.

In each of the examples described above, the control unit is responsible for defining the sequence of MAC operations that are performed by the MAC engine. For example, for each processing cycle, the control unit instructs the DMA engine to load the weight register(s) and the input registers with the appropriate values from local memory. The control unit additionally selects the inputs of the multiplexers such that the product values of the DPUs are added to the appropriate accumulators.

In the examples described above, the MAC engine comprises a plurality of multiplexers coupled between the dot product units and the adders. The inputs of the multiplexers are then selected such that each of the adders is coupled to one of the dot product units. In other examples, the MAC engine may comprise alternative components or circuitry for coupling each of the adders to one of the dot product units. Accordingly, in a more general sense, the MAC engine may be said to comprise switching circuitry coupled between the dot product units and the adders. The switching circuitry is then configurable such that each of the adders is coupled to one of the DPUs. The control unit then configures the switching circuitry with each processing cycle such that each of the adders is coupled to a selected dot product unit.

In the examples described above, the MAC engine performs a sequence of MAC operations that collectively perform a convolution operation. In other examples, the sequence of MAC operations may be used to perform alternative operations, and power savings may nevertheless be achieved through the reuse of input values.

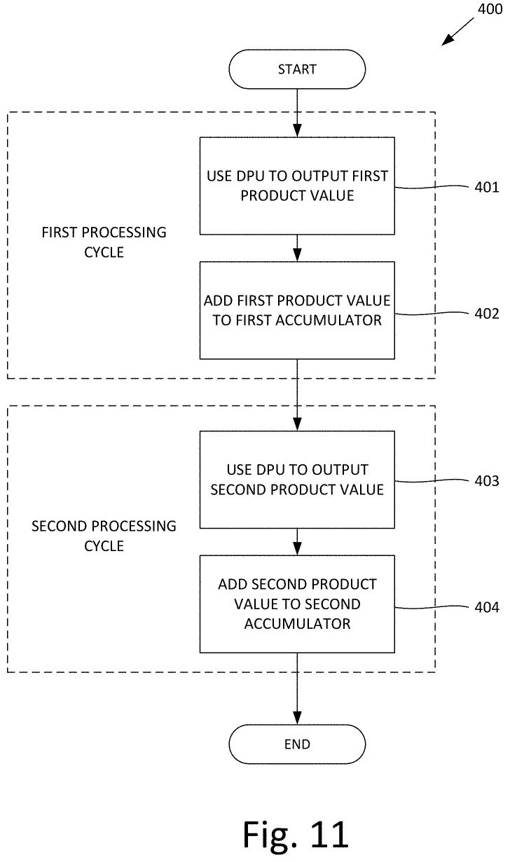

FIG. 11 illustrates a method 400 of performing multiply-accumulate operations. The method 400 may be performed using the MAC engines 200,300 of FIGS. 5 and 9.

The method 400 comprises, in a first processing cycle, using 401 a DPU to output a first product value, and adding 402 the first product value to a first accumulated value of a first accumulator. The method 400 further comprises, in a second processing cycle, using 403 the DPU to output a second product value, and adding 404 the second product value to a second accumulated value of a second accumulator. The same DPU is therefore used in both processing cycles. However, the product value output by the DPU is added to a different accumulator in different processing cycles.

The first product value may be the product of a first value and a second value, and the second product value may the product of the first value and a third value. As a result, one of the inputs to the DPU, namely the first value, is unchanged. As a result, the MAC operations may be performed at a lower power consumption. In examples, the first value may be a value of an input feature map, the second value may be a first weight of a filter, and the third value may be a second weight of the filter. Moreover, the first accumulated value may correspond to a first element of an output feature map, and the second accumulated value may correspond to a second element of the output feature map. As a result, the method may be used to perform convolution operations of a neural network.

In examples, the DPU may comprise an output coupled to a first input of a first multiplexer and to a first input of a second multiplexer. The first multiplexer may comprise one or more further inputs coupled to outputs of one or more further DPUs, and an output coupled to a first adder associated with the first accumulator. Similarly, the second multiplexer may comprise one or more further inputs coupled to the outputs of the one or more further DPUs, and an output coupled to a second adder associated with the second accumulator. The method may then comprise, in the first processing cycle, selecting the first input of the first multiplexer and selecting one of the further inputs of the second multiplexer such that the product value of the DPU is added to the first accumulated value by the first adder. In the second processing cycle, the method may comprise selecting the first input of the second multiplexer and selecting one of the further inputs of the first multiplexer such that the product value of the DPU is added to the second accumulated value by the second adder. In this way, the product value output by the DPU may be added to different accumulators in different processing cycles through appropriate selection of the inputs of the multiplexers.

It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the accompanying claims.

What is claimed is:

1. A processing unit comprising a multiply-accumulate engine and a control unit, wherein:
the multiply-accumulate engine comprises a plurality of dot product units, switching circuitry, a plurality of adders, and a plurality of accumulators;
the switching circuitry is coupled between the dot product units and the adders and is configurable to selectively couple each of the adders to one of the plurality of dot product units;
each of the adders is associated with a respective accumulator of the plurality of accumulators; and
in a processing cycle, each of the dot product units is configured to output a product value, the control unit is operable to configure the switching circuitry such that each of the adders is coupled to a selected dot product unit of the plurality of dot product units, and each of the adders is configured to add the product value of the selected dot product unit to an accumulated value stored by the respective accumulator.

2. The processing unit as claimed in claim 1, wherein:
the control unit is operable to configure the switching circuitry such that at least some of the adders are coupled to different dot product units in different processing cycles.

3. The processing unit as claimed in claim 1, wherein:
in a first processing cycle, the control unit is operable to configure the switching circuitry such that a first adder of the plurality of adders is coupled to a first dot product unit of the plurality of dot product units, and
in a second processing cycle, the control unit is operable to configure the switching circuitry such that a second adder of the plurality of adders is coupled to the first dot product unit.

4. The processing unit as claimed in claim 3, wherein:
in the first processing cycle, the first dot product unit is configured to output a first product value corresponding to a product of a first value and a second value; and
in the second processing cycle, the first dot product unit is configured to output a second product value corresponding to a product of the first value and a third value.

5. The processing unit as claimed in claim 1, wherein:
each of the dot product units is configured to output a product value corresponding to a product of a value of an input feature map and a weight of a filter, and the accumulated value of each of the accumulators corresponds to an element of an output feature map.

6. The processing unit as claimed in claim 1, wherein:
the processing unit comprises a plurality of input registers, and a weight register;
each of the dot product units comprises a first input coupled to a respective input register of the plurality of input registers, and a second input coupled to the weight register.

7. The processing unit as claimed in claim 6, wherein:
in a first processing cycle, the control unit is operable to load each of the input registers with a respective value, and to load the weight register with a first weight; and
in a second processing cycle, the control unit is operable to load a subset of the input registers with a new respective value, and load the weight register with a second weight.

8. The processing unit as claimed in claim 6, wherein:
the processing unit is operable to perform a convolution operation over a plurality of processing cycles; and
in each processing cycle of the plurality of processing cycles, the control unit is operable to load the weight register with a weight of a filter, and the weights employed in each pair of consecutive processing cycles are contiguous weights of the filter.

9. The processing unit as claimed in claim 8, wherein:
in each processing cycle of the plurality of processing cycles, the control unit is operable to load at least some of the input registers with values of an input feature map.

10. The processing unit as claimed in claim 1, wherein the switching circuitry comprises a plurality of multiplexers, each of the multiplexers comprises a plurality of inputs and an output, each of the inputs is coupled to an output of one of the dot product units, and the output is coupled to an input of a respective adder of the plurality of adders.

11. A multiply-accumulate engine comprising a plurality of dot product units, switching circuitry, a plurality of adders, and a plurality of accumulators, wherein:
the switching circuitry is coupled between the dot product units and the adders and is configurable to selectively couple each of the adders to one of the plurality of dot product units; and
each of the adders is associated with a respective accumulator of the plurality of accumulators.

12. The multiply-accumulate engine as claimed in claim 11, wherein the switching circuitry comprises a plurality of multiplexers, each of the multiplexers comprises a plurality of inputs and an output, each of the inputs is coupled to an output of one of the dot product units, and the output is coupled to an input of a respective adder of the plurality of adders.

13. A method of performing multiply-accumulate operations comprising:
in a first processing cycle, using a dot product unit to output a first product value, and adding the first product value to a first accumulated value of a first accumulator; and
in a second processing cycle, using the dot product unit to output a second product value, and adding the second product value to a second accumulated value of a second accumulator.

14. The method as claimed in claim 13, wherein the first product value is a product of a first value and a second value, and the second product value is a product of the first value and a third value.

15. The method as claimed in claim 14, wherein the first value is a value of an input feature map, the second value is a first weight of a filter, the third value is a second weight of the filter, the first accumulated value corresponds to a first element of an output feature map, and the second accumulated value corresponds to a second element of the output feature map.

16. The method as claimed in claim 14, wherein the dot product unit comprises a first input coupled to a first register and a second input coupled to a second register, the dot product unit is configured to output a product value corresponding to the product of values in the first register and the second register, and the method comprises:
in the first processing cycle: loading the first register with the first value, and loading the second register with the second value; and
in the second processing cycle: leaving the first register loaded with the first value, and loading the second register with the third value.

17. The method as claimed in claim 13, wherein:
the dot product unit comprises an output coupled to a first input of a first multiplexer and to a first input of a second multiplexer;
the first multiplexer comprises one or more further inputs coupled to outputs of one or more further dot product units, and an output coupled to a first adder associated with the first accumulator;
the second multiplexer comprises one or more further inputs coupled to the outputs of the one or more further dot product units, and an output coupled to a second adder associated with the second accumulator; and
the method comprises:
in the first processing cycle, selecting the first input of the first multiplexer and selecting one of the further inputs of the second multiplexer such that the product value of the dot product unit is added to the first accumulated value by the first adder; and
in the second processing cycle, selecting the first input of the second multiplexer and selecting one of the further inputs of the first multiplexer such that the product value of the dot product unit is added to the second accumulated value by the second adder.
